(19) United States
(12) Patent Application Publication
(10) Pub. No.: US 2013/0120264 A1
(43) Pub. Date: May 16, 2013

(54) CONTROL DEVICE

(71) Applicants: Chung-Yueh Nien, New Taipei City (TW); Wei-Yen Pan, New Taipei City (TW); Cheng-Yi Huang, New Taipei City (TW)

(72) Inventors: Chung-Yueh Nien, New Taipei City (TW); Wei-Yen Pan, New Taipei City (TW); Cheng-Yi Huang, New Taipei City (TW)

(73) Assignee: ERGZON Co., Ltd., Changhua County (TW)

(21) Appl. No.: 13/672,844

(22) Filed: Nov. 9, 2012

(30) Foreign Application Priority Data
Nov. 11, 2011 (TW) 100221402

(51) Int. Cl. G09G 5/08

(52) U.S. Cl. CPC G09G 5/08
USPC 345/167; 345/157

(57) ABSTRACT

A control device includes a supporting surface, a sensing member, a displacement generation member, and a movable member. The supporting surface is extended along a first longitudinal direction. The displacement generation member faces the sensing member. The movable member is extended along a second longitudinal direction, and linearly translatable along the first longitudinal direction of the supporting surface. When the second longitudinal direction of the movable member is parallel with the first longitudinal direction and the movable member is linearly translated along the first longitudinal direction or rolled along a direction perpendicular to the first longitudinal direction, a displacement of the movable member relative to the supporting surface synchronously results in a displacement of the displacement generation member relative to the sensing member. Moreover, a first control signal is generated in response to an interaction between the displacement generation member and the sensing member.

### FIELD OF THE INVENTION

The present invention relates to a control device, and more particularly to a control device for controlling a cursor.

### BACKGROUND OF THE INVENTION

With increasing development of the modern technologies and the electronic industries, a variety of electronic devices such as computers, notebook computers, mobile phones or digital cameras have become indispensable parts of the human lives.

Furthermore, most users may frequently come into contact with the computer and use a mouse, a keyboard or any other peripheral module to operate the computer. Generally, the conventional mouse or the conventional ergonomic cursor control device is equipped with a sensor (e.g. an optical sensor or a magnetic sensor) to detect the controlling action of the user. Due to the limitations of the sensing principle or the sensing method, the mechanism or circuitry arrangement of the optical sensor or the image sensor is usually restricted.

Therefore, there is a need of providing an improved and simplified control device for eliminating the above problems of the conventional mouse or input device while complying with the ergonomic design.

### SUMMARY OF THE INVENTION

For eliminating the drawbacks from the conventional control device, the present invention provides an improved control device. In the control device of the present invention, an interaction between a displacement generation member and a sensing member is generated in a non-optical sensing manner. According to the interaction, the linear translation or the rolling action of a movable member of the control device is correspondingly detected.

It is an object of the present invention to provide a control device, in which a sensing member or a displacement generation member is disposed on a movable member. Consequently, flexibility of designing the control device is enhanced.

It is another object of the present invention to provide a control device. The control device is suitably installed on a limited platform, or integrally formed with an electronic device to be received within a limited space. Consequently, the control device can be operated as a mouse.

In accordance with a first aspect of the present invention, there is provided a control device for controlling a movement of a cursor of an electronic device. The control device includes a supporting surface, a sensing member, a displacement generation member, and a movable member. The supporting surface is extended along a first longitudinal direction. The displacement generation member faces the sensing member. The movable member is extended along a second longitudinal direction, and linearly translatable along the first longitudinal direction of the supporting surface. When the second longitudinal direction of the movable member is parallel with the first longitudinal direction and the movable member is linearly translated along the first longitudinal direction or rolled along a direction perpendicular to the first longitudinal direction, a displacement of the movable member relative to the supporting surface synchronously results in a displacement of the displacement generation member relative to the sensing member. Moreover, a first control signal is generated in response to an interaction between the displacement generation member and the sensing member.

In an embodiment, the control device further includes a circuit board for providing the sensing member. The displacement generation member is disposed on an outer surface of the movable member that faces the circuit board.

In an embodiment, the control device further includes a holder or a supporting rod for providing the supporting surface to support the circuit board or fixing the circuit board. In addition, a length of the movable member along the second longitudinal direction is shorter than a length of the holder or the supporting rod along the first longitudinal direction. Alternatively, the control device further includes a holder or a supporting rod for providing the supporting surface and a casing for supporting the circuit board. The circuit board is arranged between the casing and the holder or the supporting rod. The movable member is sheathed around the supporting surface of the holder or the supporting rod. In addition, a length of the movable member along the second longitudinal direction is shorter than a length of the holder or the supporting rod along the first longitudinal direction.

In an embodiment, the control device further includes a circuit board for providing the sensing member and a holder or a supporting rod for providing the supporting surface and supporting the circuit board. The displacement generation member is disposed on an inner surface of the movable member that faces the circuit board. In addition, a length of the movable member along the second longitudinal direction is shorter than a length of the holder or the supporting rod along the first longitudinal direction.

In an embodiment, the control device further includes a circuit board for providing the sensing member, and the displacement generation member further includes at least one conductive structure. The interaction is generated by touching or non-touching the sensing member with the conductive structure of the generation member, and the interaction comprises resistive interaction or capacitive interaction.

In an embodiment, the control device further includes a wired connecting interface or a wireless transmission interface for outputting the first control signal. Alternatively, the control device further includes a wired connecting interface or a wireless transmission interface for outputting the first control signal and a peripheral module in communication with the wired connecting interface or the wireless transmission interface. The peripheral module and the control device are combined together or separated into two parts. The peripheral module at least comprises a scanning module, a keyboard module, a touch module, a projecting module, a camera module, an industrial computer or host, a commercial computer or host, a medical computer or host, a handheld electronic device, or a combination thereof.

In an embodiment, the control device further includes a supporting rod or a holder for providing the supporting surface and a circuit board for providing the sensing member, wherein. The displacement generation member is disposed on the supporting surface. The circuit board is disposed on an inner surface of the movable member that faces the supporting surface of the supporting rod or the holder.

In an embodiment, the control device further includes a supporting rod or a holder for providing the supporting surface. The displacement generation member is disposed on the supporting surface. The movable member is sheathed around the supporting surface and the displacement generation member. In addition, a length of the movable member along the second longitudinal direction is shorter than a length of the supporting rod or the holder along the first longitudinal direction.

In an embodiment, the control device further includes a supporting rod or a holder for providing the supporting surface. The displacement generation member includes at least one conductive structure, which is disposed on the supporting surface. The interaction is generated by touching or non-touching said sensing member with said conductive structure of said displacement generation member.

In an embodiment, the control device further includes a casing for supporting the displacement generation member and a supporting rod or a holder for providing the supporting surface. The movable member is sheathed around the supporting rod or the holder. The sensing member is disposed on an outer surface of the movable member. The outer surface of the movable member is arranged between the supporting rod and the casing, or the outer surface of the movable member is arranged between the holder and the casing.

In accordance with a second aspect of the present invention, there is provided a rollable and linearly-translatable control device for controlling a movement of a cursor of an electronic device. The rollable and linearly-translatable control device includes a displacement generation member, a movable member, and a sensing member. The movable member is rollable or linearly translatable on a supporting surface to be operated by a user. When the movable member is rolled, a central axis of the movable member is served as a rolling shaft. When the movable member is rolled or linearly translated relative to the supporting surface, a displacement of the movable member relative to the supporting surface synchronously results in an interaction between the displacement generation member and the sensing member. In addition, a first control signal is generated in response to the interaction.

In an embodiment, the displacement generation member includes at least one conductive structure, which is disposed on an outer surface of the movable member. The control device further includes a holder for providing the supporting surface and a flexible printed circuit board. The sensing member is provided by the flexible printed circuit board. When the movable member is rolled or linearly translated on the supporting surface, at least a portion of the conductive structure overlaps the sensing member of the flexible printed circuit board. Alternatively, the displacement generation member includes plural conductive blocks, which are distributed on an outer surface of the movable member. The control device further includes a holder for providing the supporting surface and a flexible printed circuit board. A first sensing pattern and a second sensing pattern of the sensing member are distributed on the flexible printed circuit board. When the movable member is rolled or linearly translated on the supporting surface, at least one of the plural conductive blocks overlaps at least one of the first sensing pattern and the second sensing pattern.

In an embodiment, the rollable and linearly-translatable control device further includes a peripheral module for receiving the first control signal. The peripheral module and the control device are combined together or separated into two parts. The peripheral module at least includes a scanning module, a keyboard module, a touch module, a projecting module, a camera module, an industrial computer or host, a commercial computer or host, a medical computer or host, a handheld electronic device, or a combination thereof.

In an embodiment, if the displacement generation member includes the at least one conductive structure, the conductive structure is selected from a metal sheet, a conductive cloth, a conductive bump, or a combination thereof. If the displacement generation member includes the plural conductive blocks, the plural conductive blocks comprise plural separate metal sheets, plural separate conductive cloths, plural separate conductive bumps, or a combination thereof.

In an embodiment, the displacement generation member includes at least one conductive structure, which is disposed on an inner surface of the movable member. The control device further includes a holder for providing the supporting surface and a flexible printed circuit board. The sensing member is provided by the flexible printed circuit board. When the movable member is rolled or linearly translated on the supporting surface, at least a portion of the conductive structure overlaps the sensing member of the flexible printed circuit board. Alternatively, the displacement generation member includes plural conductive blocks, which are distributed on an inner surface of the movable member. The control device further includes a holder for providing the supporting surface and a flexible printed circuit board. A first sensing pattern and a second sensing pattern of the sensing member are distributed on the flexible printed circuit board. When the movable member is rolled or linearly translated on the supporting surface, at least one of the plural conductive blocks overlaps at least one of the first sensing pattern and the second sensing pattern.

In an embodiment, the control device further includes a holder for providing the supporting surface and a flexible printed circuit board for providing the sensing member. The flexible printed circuit board is disposed on the movable member. The displacement generation member includes at least one conductive structure, which is disposed on the holder. When the movable member is rolled or linearly translated on the supporting surface, at least a portion of the conductive structure overlaps the sensing member of the flexible printed circuit board. Alternatively, the control device further includes a holder for providing the supporting surface and a flexible printed circuit board for providing the sensing member. The flexible printed circuit board is disposed on the movable member. The displacement generation member includes plural conductive blocks, which are distributed on the holder. A first sensing pattern and a second sensing pattern of the sensing member are distributed on the flexible printed circuit board. When the movable member is rolled or linearly translated on the supporting surface, at least one of the plural conductive blocks overlaps at least one of the first sensing pattern and the second sensing pattern.

In accordance with a third aspect of the present invention, there is provided a control device for controlling a movement of a cursor of an electronic device. The control device includes a displacement generation member, a movable member, and a flexible printed circuit board. The movable member is rollable or linearly translatable on a supporting surface to be operated by a user. The flexible printed circuit board has a sensing member. When the movable member is rolled or linearly translated relative to the supporting surface, a displacement of the movable member relative to the supporting surface synchronously results in an interaction between the displacement generation member and the sensing member. In addition, a first control signal is generated in response to the interaction.

In an embodiment, the displacement generation member includes at least one conductive structure, which is disposed on an outer surface of the movable member. The control device further includes a holder for providing the supporting surface and accommodating the movable member and the flexible printed circuit board. A first sensing pattern and a second sensing pattern of the sensing member are distributed on the flexible printed circuit board. When the movable member is rolled or linearly translated on the supporting surface, the conductive structure overlaps at least one of the first sensing pattern and the second sensing pattern. Alternatively, the displacement generation member includes at least one conductive structure, which is disposed on an inner surface of the movable member. The control device further includes a holder for providing the supporting surface and accommodating the movable member. A first sensing pattern and a second sensing pattern of the sensing member are distributed on the flexible printed circuit board. When the movable member is rolled or linearly translated on the supporting surface, the conductive structure overlaps at least one of the first sensing pattern and the second sensing pattern. Alternatively, the displacement generation member includes plural conductive blocks, which are distributed on an outer surface of the movable member. The control device further includes a holder for providing the supporting surface and accommodating the movable member and the flexible printed circuit board. A first sensing pattern and a second sensing pattern of the sensing member are distributed on the flexible printed circuit board. When the movable member is rolled or linearly translated on the supporting surface, at least one of the plural conductive blocks overlaps at least one of the first sensing pattern and the second sensing pattern. Alternatively, the displacement generation member includes plural conductive blocks, which are distributed on an inner surface of the movable member. The control device further includes a holder for providing the supporting surface and accommodating the movable member and the flexible printed circuit board. A first sensing pattern and a second sensing pattern of the sensing member are distributed on the flexible printed circuit board. When the movable member is rolled or linearly translated on the supporting surface, at least one of the plural conductive blocks overlaps at least one of the first sensing pattern and the second sensing pattern.

In an embodiment, the first sensing pattern and the second sensing pattern are distributed on the flexible printed circuit board, and the first sensing pattern and the second sensing pattern are separated from each other, located adjacent to each other or staggered relative to each other. If the displacement generation member includes the at least one conductive structure, the conductive structure is selected from a metal sheet, a conductive cloth, a conductive bump, or a combination thereof. If the displacement generation member includes the plural conductive blocks, the plural conductive blocks comprise plural separate metal sheets, plural separate conductive cloths, plural separate conductive bumps, or a combination thereof.

In an embodiment, the control device further includes a peripheral module for receiving the first control signal in a wired transmission manner or a wireless transmission manner. The peripheral module and the control device are combined together or separated into two parts. The peripheral module at least includes a scanning module, a keyboard module, a touch module, a projecting module, a camera module, an industrial computer or host, a commercial computer or host, a medical computer or host, a handheld electronic device, or a combination thereof.

In an embodiment, the control device further includes a holder for providing the supporting surface. The flexible printed circuit board is disposed on the movable member. The displacement generation member includes at least one conductive structure, which is disposed on the holder. A first sensing pattern and a second sensing pattern of the sensing member are distributed on the flexible printed circuit board. When the movable member is rolled or linearly translated on the supporting surface, the conductive structure overlaps at least one of the first sensing pattern and the second sensing pattern. Alternatively, the control device further includes a holder for providing the supporting surface. The flexible printed circuit board is disposed on the movable member. The displacement generation member includes plural conductive blocks, which are disposed on the holder. A first sensing pattern and a second sensing pattern of the sensing member are distributed on the flexible printed circuit board. When the movable member is rolled or linearly translated on the supporting surface, at least one of the plural conductive blocks overlaps at least one of the first sensing pattern and the second sensing pattern.

In accordance with a fourth aspect of the present invention, there is provided a control device for controlling a movement of a cursor of an electronic device. The control device includes a touch-type displacement generation member, a roll-bar-type removable member, and a touch-type sensing member. The roll-bar-type removable member is rollable or linearly translatable on a supporting surface to be operated by a user. When the roll-bar-type movable member is rolled or linearly translated relative to the supporting surface, a displacement of the roll-bar-type movable member relative to the supporting surface synchronously results in an interaction between the touch-type displacement generation member and the touch-type sensing member. In addition, a first control signal is generated in response to the interaction.

In an embodiment, the control device further includes a holder for providing the supporting surface and a flexible printed circuit board for providing the sensing member. The displacement generation member includes at least one conductive structure, which is disposed on a surface of the roll-bar-type removable member. The touch-type sensing member includes a first sensing pattern and a second sensing pattern. When the roll-bar-type removable member is rolled or linearly translated on the supporting surface, at least a portion of the conductive structure overlaps at least one of the first sensing pattern and the second sensing pattern of the flexible printed circuit board. Alternatively, the control device further includes a holder for providing the supporting surface and a flexible printed circuit board. The displacement generation member includes plural conductive blocks, which are distributed on a surface of the roll-bar-type removable member. A first sensing pattern and a second sensing pattern of the touch-type sensing member includes are distributed on the flexible printed circuit board. When the roll-bar-type removable member is rolled or linearly translated on the supporting surface, at least one of the plural conductive blocks overlaps at least one of the first sensing pattern and the second sensing pattern.

In an embodiment, the surface of the roll-bar-type removable member is an inner surface or an outer surface.

In an embodiment, the control device further includes a peripheral module for receiving the first control signal in a wired transmission manner or a wireless transmission manner. The peripheral module and the control device are combined together or separated into two parts. The peripheral module at least includes a scanning module, a keyboard module, a touch module, a projecting module, a camera module, an industrial computer or host, a commercial computer or host, a medical computer or host, a handheld electronic device, or a combination thereof.

In an embodiment, the first sensing pattern and the second sensing pattern are distributed on the flexible printed circuit board, and the first sensing pattern and the second sensing pattern are separated from each other, located adjacent to each other or staggered relative to each other. If the displacement generation member includes the at least one conductive structure, the conductive structure is selected from a metal sheet, a conductive cloth, a conductive bump, or a combination thereof. If the displacement generation member includes the plural conductive blocks, the plural conductive blocks comprise plural separate metal sheets, plural separate conductive cloths, plural separate conductive bumps, or a combination thereof.

In an embodiment, the control device further includes a holder for providing the supporting surface. The flexible printed circuit board is disposed on the roll-bar-type movable member. The displacement generation member includes at least one conductive structure, which is disposed on the holder. A first sensing pattern and a second sensing pattern of the touch-type sensing member are distributed on the flexible printed circuit board. When the movable member is rolled or linearly translated on the supporting surface, at least a portion of the conductive structure overlaps at least one of the first sensing pattern and the second sensing pattern. Alternatively, the control device further includes a holder for providing the supporting surface. The flexible printed circuit board is disposed on the roll-bar-type movable member. The displacement generation member includes plural conductive blocks, which are disposed on the holder. A first sensing pattern and a second sensing pattern of the touch-type sensing member are distributed on the flexible printed circuit board. When the movable member is rolled or linearly translated relative to the supporting surface, at least one of the plural conductive blocks overlaps at least one of the first sensing pattern and the second sensing pattern.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a control device according to a first embodiment of the present invention;

FIG. 2 is a schematic exploded view illustrating a control device according to a second embodiment of the present invention;

FIG. 3 is a schematic exploded view illustrating a control device according to a third embodiment of the present invention;

FIG. 4 is a schematic exploded view illustrating a control device according to a fourth embodiment of the present invention;

FIG. 5 is a schematic exploded view illustrating a control device according to a fifth embodiment of the present invention;

FIG. 6 is a schematic exploded view illustrating a control device according to a sixth embodiment of the present invention;

FIG. 7 is a schematic exploded view illustrating a control device according to a seventh embodiment of the present invention;

FIG. 8 is a schematic planar view illustrating an exemplary sensing member used in the control device of the present invention;

FIG. 9 is a schematic planar view illustrating a first sensing pattern of the sensing member of FIG. 8;

FIG. 10 is a schematic planar view illustrating a second sensing pattern of the sensing member of FIG. 8;

FIG. 11 is a schematic perspective view illustrating a first application environment of the control device according to the first embodiment of the present invention;

FIG. 12 is a schematic perspective view illustrating a second application environment of the control device according to the first embodiment of the present invention;

FIG. 13 is a schematic perspective view illustrating a control device according to an eighth embodiment of the present invention;

FIG. 14 is a schematic perspective view illustrating a control device according to a ninth embodiment of the present invention; and

FIG. 15 is a schematic perspective view illustrating a control device according to a tenth embodiment of the present invention.

### DETAILED DESCRIPTION OF THE PREFERRED EMBODIMENT

In this context, the term “circuit board” denotes a flexible print circuit board or a rigid printed circuit board. The flexible print circuit board is produced by etching a flexible copper clad laminate (FCCL) while retaining the desired electrical traces. One or more specified electrical traces are used as the sensing pattern of a sensing member of the present invention. Optionally, the circuit board used in the present invention may be implemented by a conventional touchpad or a conventional sensing board. For example, the sensing member may be provided by forming a specified matrix on a transparent conductive film such as an indium tin oxide (ITO) film.

In this context, the term “sensing member” denotes a resistive sensing member or a capacitive sensing member according to the sensing action. The capacitive sensing member includes a surface capacitive sensing member, a projected capacitive sensing member (e.g. a multi-touch capacitive sensing member), or the like. For designing the sensing member, the functions of operating the control device to control the horizontal movement or the vertical movement of a cursor shown on a display screen should be taken into consideration. For achieving the purposes, the sensing member comprises a first sensing pattern for generating a horizontal movement signal and a second sensing pattern for generating a vertical movement signal. The first sensing pattern and the second sensing pattern may be located adjacent to each other, separated from each other, or staggered relative to each other. In a case that the sensing member is provided by a multilayered circuit board, the first sensing pattern and the second sensing pattern may be formed on the same layer or different layers.

In this context, the term “rolling action” denotes a rotation of an object relative to a fixed shaft or a rolling motion of an object relative to a moving shaft (i.e. a central axis of the object itself). In other words, the “rolling action” includes the rotation and the rolling motion.

Moreover, according to the use or design requirements, the movable member used in the control device of the present invention may be made of a hard material or a soft material. Alternatively, the movable member is a single-layered structure or a multilayered structure. Alternatively, different portions of the movable member along a longitudinal direction may be made of an identical material or different materials. Alternatively, the movable member may be transparent or opaque. Alternatively, the movable member may be solid or hollow. Alternatively, the movable member may be equipped with a vacant portion, a through hole or a recess. Alternatively, the movable member may be an integral structure or composed of plural parts.

Moreover, the holder used in the present invention may have a flat surface or a curved surface. Alternatively, the holder may be equipped with a trench with a depth or different depths. Moreover, the holder may provide a supporting surface. In addition, a circuit module, a signal processing circuit, a wired connecting interface, a wireless transmission interface or other peripheral modules may be accommodated or disposed within the holder.

In this context, the term “displacement generation member” denotes the structure that interacts with the sensing member. In a case that a displacement of the displacement generation member relative to the sensing member occurs, a resistive interaction or a capacitive interaction between the displacement generation member and the sensing member is generated. The displacement generation member may be a continuous-surface conductive structure (such as a metal sheet, a conductive cloth, a touch plate or a continuous plane with plural conductive bumps). In a case that the movable member of the control device is rolled or linearly translated to result in the displacement between the conductive structure and the sensing member, at least one part of the conductive structure faces or overlaps the sensing member to generate an interaction. Optionally, the displacement generation member may comprise plural separate conductive blocks. For example, the separate conductive blocks comprise separate metal sheets, separate metal rings, separate conductive cloths, separate conductive bumps, or the combination thereof. In a case that the movable member of the control device is rolled or linearly translated to result in the displacement between the plural conductive blocks and the sensing member, at least one of the plural conductive blocks faces or overlaps the sensing member to generate an interaction.

In a case that the displacement generation member is disposed on the movable member, the entire of the conductive structure or the conductive blocks may be disposed on the movable member. As the movable member is linearly translated (along the X-axis direction) or rolled (along the Y-axis direction), the displacement generation member responsible for another direction control signal is also correspondingly moved with the movable member. The applications of the present invention are not limited thereto. The separate conductive bumps may be located at different positions. For example, the displacement generation member responsible for the X-axis direction control signal may be disposed on a carrier different from the movable member and not linearly translated with the movable member; and the displacement generation member responsible for the Y-axis direction control signal may be disposed on the carrier sheathed around the movable member and rolled with the movable member, and vice versa. Consequently, as the movable member is moved, the part of the displacement generation member disposed on the movable member is rolled with the movable member, but the other part of the displacement generation member disposed on the carrier different from the movable member is not rolled with the movable member. Otherwise, as the movable member is linearly translated, the part of the displacement generation member disposed on the movable member is linearly translated with the movable member, but the other part of the displacement generation member disposed on the carrier different from the movable member is not linearly translated with the movable member.

The sensing member and the displacement generation member used in the control device of the present invention will be described more specifically with reference to the following embodiments. The positions of the sensing member and the displacement generation member may be exchanged as long as a displacement between the sensing member and the displacement generation member can be generated in response to the user's manipulation on the control device. In other words, the modifications about the exchanged arrangements of the sensing member and the displacement generation member are included within the spirit and scope of the present invention.

In the following embodiments, the ways of linearly translating or rolling the movable member to operate the control device are presented herein for purpose of illustration and description only. It is noted that the operation of the control device of the present invention is not limited to the detection of the linear translation and the rolling action. For example, in a case that the control device is used to control a cursor of an electronic device, the action of resetting the cursor and the approach of detecting the cursor may be implemented by triggering a switch after the movable member is linearly translated for a certain distance. For example, the control device of the present invention may be equipped with a micro switch or a magneto resistive sensor (MR sensor) at a specified position to detect the terminal point and reset the cursor. Alternatively, the control device of the present invention may be equipped with a mechanical switch at a specified position. By pushing the mechanical switch, the cursor on the display screen of the electronic device may be moved to a reset point.

In this context, the term “wired connecting interface” includes but is not limited to a USB interface, a PS2 interface or any other wired connecting interface. Moreover, the term “wireless connecting interface” includes a Bluetooth interface, an infrared interface, a radio frequency (RF) interface, or any other wireless connecting interface.

The control device of the present invention may control a horizontal movement or a vertical movement of a cursor of an electronic device. Furthermore, the control device of the present invention may cooperate with other mechanisms or peripheral modules to implement more functions. For example, the control device of the present invention may further comprise a pushing module for implementing a general cursor click. Alternatively, the control device of the present invention may further comprise a reset module for implementing a cursor reset. Alternatively, the control device of the present invention may further comprise a scanning module. The scanning module is in communication with the wired connecting interface or the wireless transmission interface of the control device. Consequently, the control device may be used to selectively implement a cursor control function or a scanning function. Alternatively, the control device of the present invention may further comprise a keyboard module. The keyboard module is in communication with the wired connecting interface or the wireless transmission interface. Consequently, the control device may be used to collectively implement the functions of a mouse and a keyboard. The above descriptions are presented herein for purpose of illustration and description only. It is noted that numerous modifications and alterations may be made while retaining the teachings of the invention.

Moreover, in the this context, the term “peripheral module” includes but is not limited to the pushing module, the reset module, the scanning module, the keyboard module, a touch module, a projecting module, a camera module, an industrial computer or host, a commercial computer or host, a medical computer or host, or a handheld electronic device. Moreover, the electronic device may be an individual component or device, which is in communication with the control device of the present invention in a wired transmission manner or in a wireless transmission manner. Alternatively, the electronic device and the control device of the present invention may be combined together.

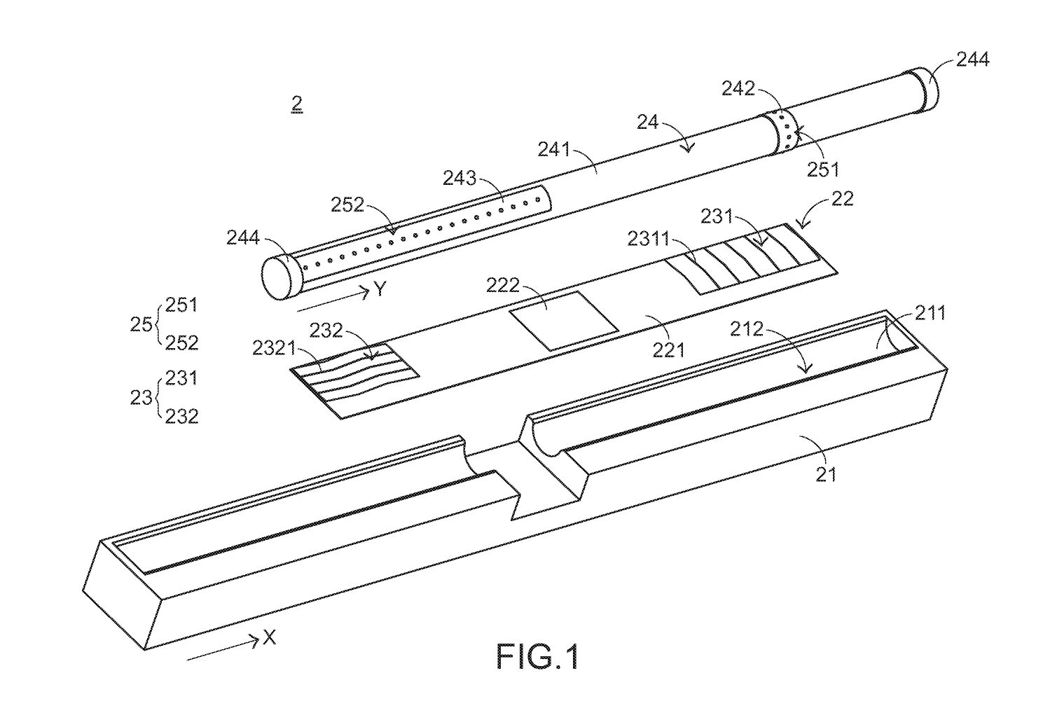

FIG. 1 is a schematic exploded view illustrating a control device according to a first embodiment of the present invention. As shown in FIG. 1, the control device 2 comprises a holder 21, a circuit module 22, and a movable member 24. In this embodiment, the holder 21 comprises a trench 212. A portion of the trench 212 or the entire trench 212 provides a supporting surface 211. The trench 212 may have an arc-shaped surface, a flat surface or a curved surface. In views of the outward appearance, the trench 212 is substantially an elongated trench extended along a first longitudinal direction X. Consequently, the supporting surface 211 has an arc-shaped surface, a flat surface or a curved surface, and the supporting surface 211 is also extended along the first longitudinal direction X. Moreover, the trench 212 is used for accommodating the movable member 24. In views of the outward appearance, the movable member 24 is substantially an elongated cylinder extended along a second longitudinal direction Y. Consequently, after the movable member 24 is accommodated within the trench 212, the second longitudinal direction Y of the movable member 24 is parallel with the first longitudinal direction X. Moreover, the length of the movable member 24 along the second longitudinal direction Y is shorter than the length of the supporting surface 211 along the first longitudinal direction X. Consequently, after the movable member 24 is accommodated within the trench 212, the second longitudinal direction Y of the movable member 24 is parallel with the first longitudinal direction X, and the movable member 24 may be linearly translated along the first longitudinal direction X of the supporting surface 211. Moreover, in this embodiment, after the movable member 24 is accommodated within the trench 212, the movable member 24 may be rolled in a direction perpendicular to the first longitudinal direction X.

The circuit module 22 is disposed on the holder 21. In this embodiment, the circuit module 22 comprises a flexible print circuit board 221. According to the contour of the supporting surface 211 of the trench 212, the flexible print circuit board 221 is disposed on the holder 21, or the flexible print circuit board 221 is fixed in the holder 21 and located near the trench 212. Consequently, the flexible print circuit board 221 may have an arc-shaped surface, a flat surface or a curved surface. Moreover, a sensing member 23 and a processor 222 are disposed on the flexible print circuit board 221. The sensing member 23 is in communication with the processor 222. The processor 222 is used to process the signal from the sensing member 23, thereby generating a control signal. The control signal is then transmitted to an external electronic device (not shown) through a wired connecting interface or a wireless transmission interface (not shown) in order to control a movement of a cursor of the external electronic device. Alternatively, in some other embodiments, the flexible print circuit board 221 is replaced by a rigid print circuit board. The other components are similar to those of the control device with the flexible print circuit board 221, and are not redundantly described herein.

Please refer to FIG. 1 again. In this embodiment, the sensing member 23 comprises a first sensing pattern 231 and a second sensing pattern 232. The first sensing pattern 231 and the second sensing pattern 232 are distributed on different regions of the flexible print circuit board 221. The first sensing pattern 231 and the second sensing pattern 232 are different from each other in order to sense different motions. In this embodiment, the first sensing pattern 231 comprises plural strip-like electrical traces 2311, which are discretely arranged and parallel with each other. The plural strip-like electrical traces 2311 are oriented along a direction perpendicular to the first longitudinal direction X. The second sensing pattern 232 comprises plural strip-like electrical traces 2321, which are discretely arranged and parallel with each other. The plural strip-like electrical traces 2321 are oriented along a direction parallel with the first longitudinal direction X. The geometrical shapes of the plural electrical traces 2311 (or the plural strip-like electrical traces 2321) may be identical or different. Moreover, the plural electrical traces 2311 (or the plural electrical traces 2321) may be discretely arranged at a regular interval or at different intervals. Moreover, the geometrical shapes of the plural electrical traces 2311 (or the plural electrical traces 2321) are not restricted to the strip-like shapes. For example, the plural electrical traces 2311 (or the plural electrical traces 2321) may have regular or irregular curved or saw-toothed shapes. Consequently, according to the number, the geometric shape and the distribution of the plural electrical traces 2311 (or the plural electrical traces 2321), the resolution or accuracy of a physical quantity in response to an interaction may be adjusted.

Moreover, in this embodiment, the first sensing pattern 231 and the second sensing pattern 232 are located at two opposite sides of the processor 222, respectively. However, the positions of the first sensing pattern 231, the second sensing pattern 232 and the processor 222 are not restricted to those described in the first embodiment as long as the actual cursor movement can be sensed by the first sensing pattern 231 and the second sensing pattern 232. The way of sensing the actual cursor movement will be illustrated later. Moreover, the first sensing pattern 231, the second sensing pattern 232 and the processor 222 may be located at the same flexible print circuit board 221. Alternatively, in some other embodiments, the first sensing pattern 231, the second sensing pattern 232 and the processor 222 may be located at plural circuit boards, respectively.

The movable member 24 is movably disposed on the circuit module 22, and movably accommodated within the trench 212 of the holder 21. In this embodiment, a displacement generation member 25 is disposed on an outer surface 241 of the movable member 24. The displacement generation member 25 comprises plural conductive blocks, for example a first displacement generation block 251 and a second displacement generation block 252. The first displacement generation block 251 and the second displacement generation block 252 are located at different positions of the outer surface 241 of the movable member 24. Moreover, the displacement generation member 25 faces the sensing member 23. In particular, the first displacement generation block 251 faces the first sensing pattern 231, and the second displacement generation block 252 faces the second sensing pattern 232. In a first situation, a displacement of the movable member 24 relative to the supporting surface 211 synchronously results in a displacement of the first displacement generation block 251 relative to the first sensing pattern 231, and the first displacement generation block 251 partially or completely overlaps the first sensing pattern 231 to generate an interaction. In a second situation, a displacement of the movable member 24 relative to the supporting surface 211 synchronously results in a displacement of the second displacement generation block 252 relative to the second sensing pattern 232, and the second displacement generation block 252 partially or completely overlaps the second sensing pattern 232 to generate an interaction. Moreover, for increasing the producing or assembling ease, the first displacement generation block 251 and the second displacement generation block 252 are previously formed on a first carrier 242 and a second carrier 243, and then the first carrier 242 and the second carrier 243 are fixed on the movable member 24. It is noted that numerous modifications and alterations may be made while retaining the teachings of the invention. For example, if a suitable material and a high production yield are available, the first displacement generation block 251 and the second displacement generation block 252 may be directly formed on the outer surface 241 of the movable member 24.

In this embodiment, the movable member 24 further comprises two terminal parts 244. The two terminal parts 244 are respectively located at two ends of the movable member 24 along the second longitudinal direction Y. In addition, the two terminal parts 244 are protruded over the outer surface 241 of the movable member 24. Since the two terminal parts 244 are protruded over the outer surface 241 of the movable member 24, after the movable member 24 is disposed on the supporting surface 211, the movable member 24 is separated from the flexible print circuit board 221 by a spacing interval. Under this circumstance, the displacement generation member 25 may comprises conductors, and the sensing member 23 further comprises a capacitor layer. Consequently, a displacement of the movable member 24 relative to the supporting surface 211 synchronously results in a displacement of the displacement generation member 25 relative to the sensing member 23. At the same time, a non-contact-type capacitive interaction between the displacement generation member 25 and the sensing member 23 is generated. Alternatively, in some other embodiments, the movable member 24 is not equipped with the terminal parts 244. Consequently, there is no spacing interval between the movable member 24 and the flexible print circuit board 221. Under this circumstance, a contact-type capacitive interaction between the displacement generation member 25 and the sensing member 23 is generated.

Optionally, in this embodiment, the displacement generation member 25 comprises plural salient points, which are protruded over the outer surface 241 of the movable member 24. Since the displacement generation member 25 is protruded over the outer surface 241 of the movable member 24, after the movable member 24 is disposed on the supporting surface 211, the displacement generation member 25 is contacted with the flexible print circuit board 221. Under this circumstance, the sensing member 23 comprises a resistive pattern. Consequently, a displacement of the movable member 24 relative to the supporting surface 211 synchronously results in a displacement of the displacement generation member 25 relative to the sensing member 23. At the same time, a contact-type resistive interaction between the displacement generation member 25 and the sensing member 23 is generated.

In a case that the second longitudinal direction Y of the movable member 24 is parallel with the first longitudinal direction X and the movable member 24 is linearly translated along the first longitudinal direction X, the displacement of the first displacement generation block 251 of the displacement generation member 25 relative to the first sensing pattern 231 of the sensing member 23 is synchronously generated. At the same time, an interaction between the first displacement generation block 251 of the displacement generation member 25 and the first sensing pattern 231 of the sensing member 23 is generated. After the information about the interaction is transmitted to and processed by the processor 22, the process 22 generates a control signal (also referred as a first control signal). The first control signal is transmitted to an external electronic device through a wired connecting interface or a wireless transmission interface (not shown) in order to control a horizontal movement of the cursor of the external electronic device.

Whereas, in case that the second longitudinal direction Y of the movable member 24 is parallel with the first longitudinal direction X and the movable member 24 is rolled along a direction perpendicular to the first longitudinal direction X, the displacement of the second displacement generation block 252 of the displacement generation member 25 relative to the second sensing pattern 232 of the sensing member 23 is synchronously generated. At the same time, an interaction between the second displacement generation block 252 of the displacement generation member 25 and the second sensing pattern 232 of the sensing member 23 is generated. After the information about the interaction is transmitted to and processed by the processor 22, the process 22 generates another control signal. This control signal is transmitted to the external electronic device through the wired connecting interface or the wireless transmission interface (not shown) in order to control a vertical movement of the cursor of the external electronic device.

From the above discussions, as the movable member 24 is moved, the displacement generation member 25 disposed on the movable member 24 is moved relative to a specified sensing pattern of the sensing member to result in a displacement. Moreover, an interaction between the displacement generation member 25 and the specified sensing pattern of the sensing member is generated according to the approach of generating the displacement. In response to the interaction, a corresponding control signal is generated. In a case that the second longitudinal direction Y of the movable member 24 is parallel with the first longitudinal direction X and the movable member 24 is linearly translated along the first longitudinal direction X, the displacement of the first displacement generation block 251 of the displacement generation member 25 relative to the first sensing pattern 231 of the sensing member 23 is synchronously generated. Meanwhile, the displacement of the second displacement generation block 252 of the displacement generation member 25 relative to the second sensing pattern 232 of the sensing member 23 is synchronously generated and the interaction is also generated. However, during the movable member 24 is linearly translated along the first longitudinal direction X, the interaction between the second displacement generation block 252 and the second sensing pattern 232 is much lower than the interaction between the first displacement generation block 251 and the first sensing pattern 231. Under this circumstance, the interaction between the second displacement generation block 252 and the second sensing pattern 232 may be ignored, or this interaction may be deleted by a circuit of the circuit module 22.

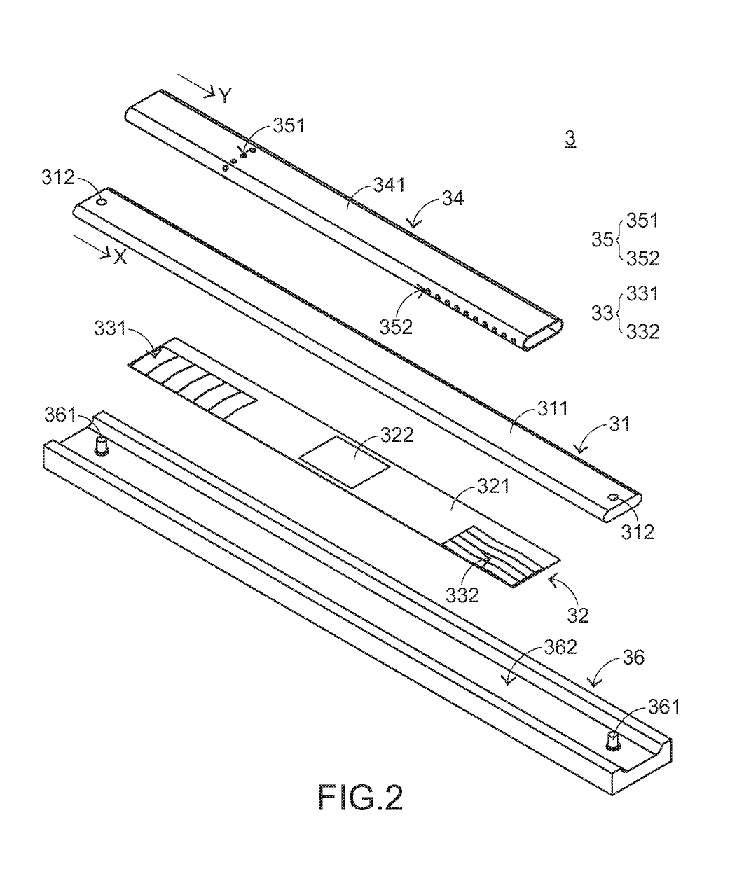

FIG. 2 is a schematic exploded view illustrating a control device according to a second embodiment of the present invention. As shown in FIG. 2, the control device 3 comprises a holder 31, a circuit module 32, and a movable member 34. In this embodiment, the control device 3 further comprises a casing 36. The casing 36 comprises a trench 362 and two fixing parts 361. The two fixing parts 361 are located at two opposite sides of the elongated trench 362, respectively. The circuit module 32 comprises a circuit board 321 (e.g. a flexible print circuit board or a rigid print circuit board). The circuit board 321 is disposed within the trench 362 of the casing 321. A sensing member 33 and a processor 322 are disposed on the circuit board 321. The sensing member 33 comprises a first sensing pattern 331 and a second sensing pattern 332.

In views of the outward appearance, the holder 31 is substantially a long flat plate extended along a first longitudinal direction X. A surface of the holder 31 may be used as a supporting surface 311. The holder has two fixing holes 312, which are respectively located at two opposite sides of the holder 31 along the first longitudinal direction X. Moreover, the long flat holder 31 is accommodated within the trench 362 of the casing 36, and the two fixing holes 312 are engaged with the two fixing parts 361 of the casing 36, respectively. Consequently, the holder 31 is fixed in the trench 362 of the casing 36. In this embodiment, the supporting surface 311 of the holder 31 is separated from the circuit module 32 by a spacing interval. That is, the long flat holder 31 provides the supporting surface 311, and the supporting surface 311 is also extended along the first longitudinal direction X. The outward appearance of the holder 31 as shown in FIG. 2 is presented herein for purpose of illustration and description only. It is noted that numerous modifications and alterations may be made while retaining the teachings of the invention. For example, the holder 31 may have an arc-shaped surface, a curved surface or any other shaped surface. Moreover, according to the practical requirements, the holder 31 is completely solid, partially solid or hollow.

In views of the outward appearance, the movable member 34 is substantially an elongated bar extended along a second longitudinal direction Y. In comparison with the first embodiment, the movable member 34 has a central hollow portion. In addition, the movable member 34 is sheathed around the supporting surface 311 of the holder 31, so that an outer surface 341 of the movable member 34 faces the circuit board 321 of the circuit module 32. Moreover, after the movable member 34 is sheathed around the supporting surface 311 of the holder 31, the movable member 34 is may be linearly mover or rolled on the supporting surface 311. Consequently, the length of the movable member 34 along the second longitudinal direction Y is shorter than the length of the supporting surface 311 along the first longitudinal direction X. Moreover, the perimeter of the central hollow portion of the movable member 34 is slightly larger than the perimeter of the holder 31 which is oriented along a direction perpendicular to the first longitudinal direction X. Moreover, a displacement generation member 35 is disposed on the outer surface 341 of the movable member 34. The displacement generation member 35 comprises a first displacement generation block 351 and a second displacement generation block 352. After the movable member 34 is sheathed around the supporting surface 311 of the holder 31, the first displacement generation block 351 and the second displacement generation block 352 face the first sensing pattern 331 and the second sensing pattern 332 of the sensing member 33, respectively. Similarly, a displacement of the movable member 34 relative to the supporting surface 311 synchronously results in a displacement of the displacement generation member 35 relative to the sensing member 33. In addition, according to the interaction between the displacement generation member 35 and the sensing member 33, a control signal is generated. The way of generating the control signal by the control device of the second embodiment is similar to that of the first embodiment, and is not redundantly described herein.

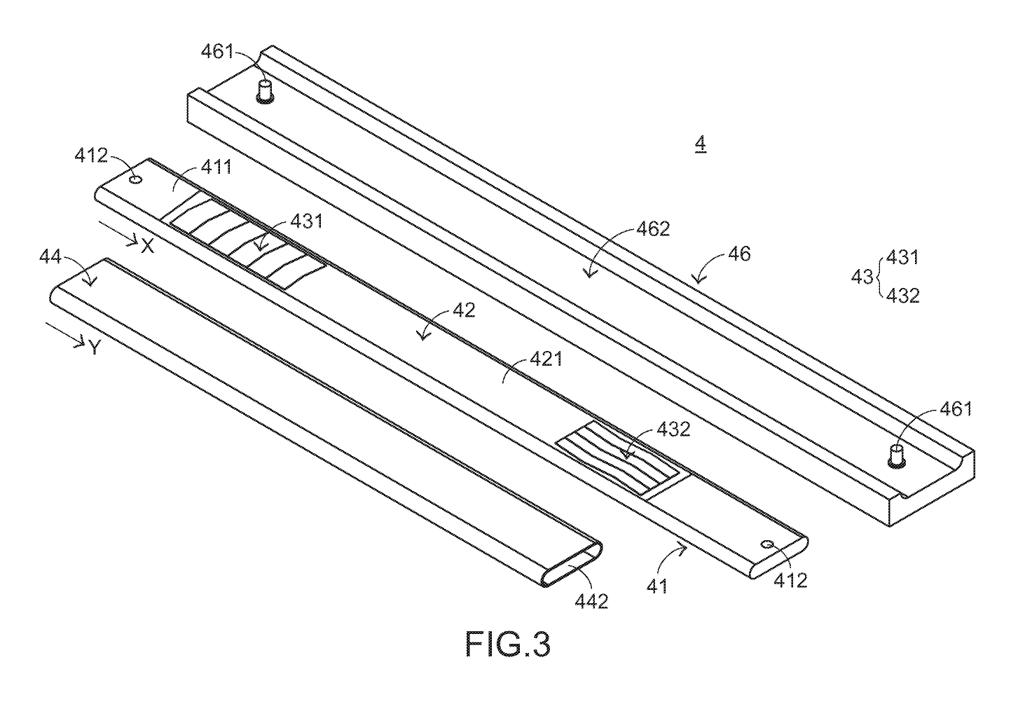

FIG. 3 is a schematic exploded view illustrating a control device according to a third embodiment of the present invention. As shown in FIG. 3, the control device 4 comprises a holder 41, a circuit module 42, a movable member 44, and a casing 46. The casing 46 comprises a trench 462 and two fixing parts 461. The two fixing parts 461 are located at two opposite sides of the elongated trench 462, respectively. Due to the engagement between two fixing holes 412 of the holder 41 and corresponding fixing parts 461 of the casing 46, the holder 41 is fixed in the trench 462 of the casing 46. In comparison with the second embodiment, the surface of the holder 41 which is far from the trench 462 is used as a supporting surface 411, and the circuit module 42 is disposed on the supporting surface 411. The circuit module 42 comprises a circuit board 421 (e.g. a flexible print circuit board or a rigid print circuit board). A sensing member 43 is disposed on the circuit board 421, wherein the sensing member 43 comprises a first sensing pattern 431 and a second sensing pattern 432. The sensing member 43 is exposed outside the supporting surface 411. Alternatively, the sensing member 43 is fixed in the holder 41 and located near the supporting surface 411. A processor (not shown) is also located at the same side of the supporting surface 411 with respect to the holder 41. Moreover, the holder 41 has a recess (not shown) for accommodating the processor. Alternatively, the holder 41 has no recess.

Moreover, the position of the displacement generation member (not shown) of the third embodiment is distinguished from the position of the displacement generation member 35 of the second embodiment. In this embodiment, the displacement generation member is disposed on an inner surface 442 of the hollow movable member 44. After the movable member 44 is sheathed around the holder 41, the inner surface 442 of the hollow movable member 44 faces the supporting surface 411 of the holder 41. Consequently, the displacement generation member on the inner surface 442 of the hollow movable member 44 and the sensing member 43 on the supporting surface 411 still face each other. In other words, when the displacement generation member is disposed on the inner surface 442 of the hollow movable member 44, the displacement generation member still faces the sensing member 43. Consequently, the displacement generation member and the sensing member overlap each other to achieve the purpose of the present invention.

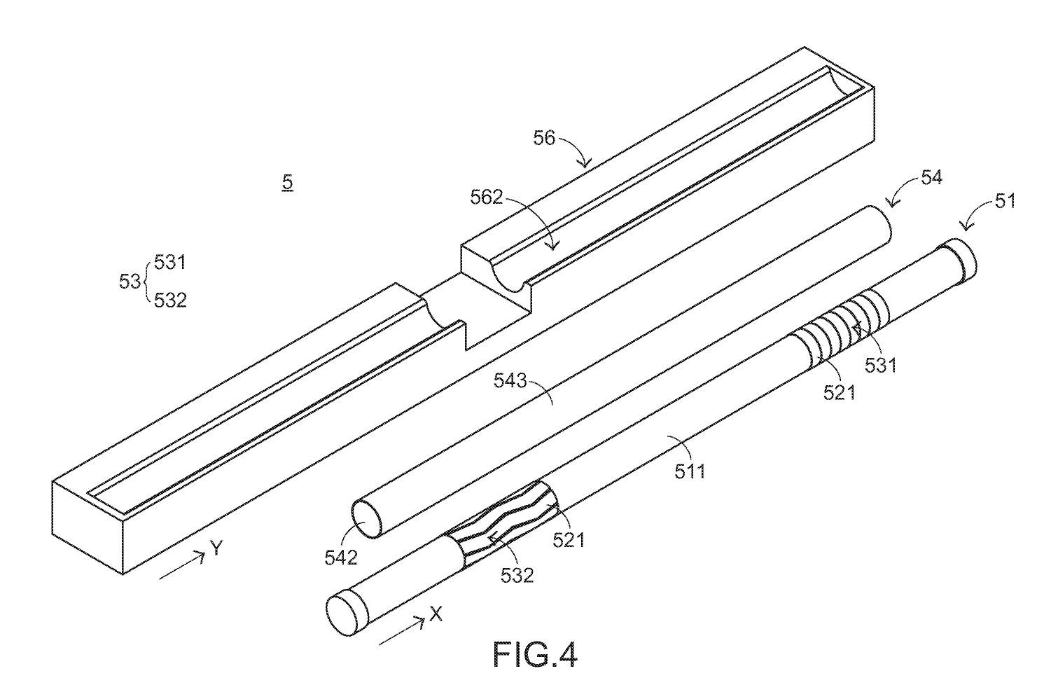

FIG. 4 is a schematic exploded view illustrating a control device according to a fourth embodiment of the present invention. As shown in FIG. 4, the control device 5 comprises a holder 51, plural circuit boards 521 (e.g. two circuit boards), a movable member 54, and a casing 56. The casing 56 has a trench 562. In comparison with the third embodiment, the holder 51 is substantially a cylindrical supporting rod. After the movable member 54 is sheathed around the holder 51, the holder 51 is accommodated within the trench 562. An outer surface of the holder 51 is used as a supporting surface 511. The two circuit boards 521 are disposed on the supporting surface 511. A first sensing pattern 531 and a second sensing pattern 532 of the sensing member 53 are disposed on the two circuit boards 521, respectively. A processor (not shown) and other signal processing circuits (not shown) may be disposed on other circuit boards, which may be disposed on the supporting surface 511 or disposed within a hollow portion or a recess (not shown) of the holder 51.

The displacement generation member of the fourth embodiment is similar to the displacement generation member of the third embodiment. In this embodiment, the displacement generation member is disposed on an inner surface 542 of the hollow movable member 54. After the movable member 54 is sheathed around the holder 51, the inner surface 542 of the hollow movable member 54 faces the supporting surface 511 of the holder 51. Consequently, the displacement generation member on the inner surface 542 of the hollow movable member 54 and the sensing member 53 on the supporting surface 511 still face each other. Moreover, in this embodiment, the movable member 54 may be made of a hard material, but is not limited thereto. For example, the movable member 54 may be also made of a soft material. Moreover, since the displacement generation member is disposed on an inner surface 542 of the movable member 54, another structure such as a friction structure may be formed on an outer surface 543 of the movable member 54 in order to enhance the touch feel of linearly translating or rolling the movable member 54.

In the above embodiments, the displacement generation member is disposed on the entire movable member. As the movable member is operated by the user, the user's finger can be directly contacted with the displacement generation member. It is noted that numerous modifications and alterations may be made while retaining the teachings of the invention. For example, in some other embodiments, the length of the movable member may be prolonged as long as the length of the movable member is kept shorter than the length of the supporting surface. Under this circumstance, the displacement generation member may be disposed on a specified region of the movable member. Consequently, when the movable member is touched and operated by the user, the user does not feel the presence of the displacement generation member.

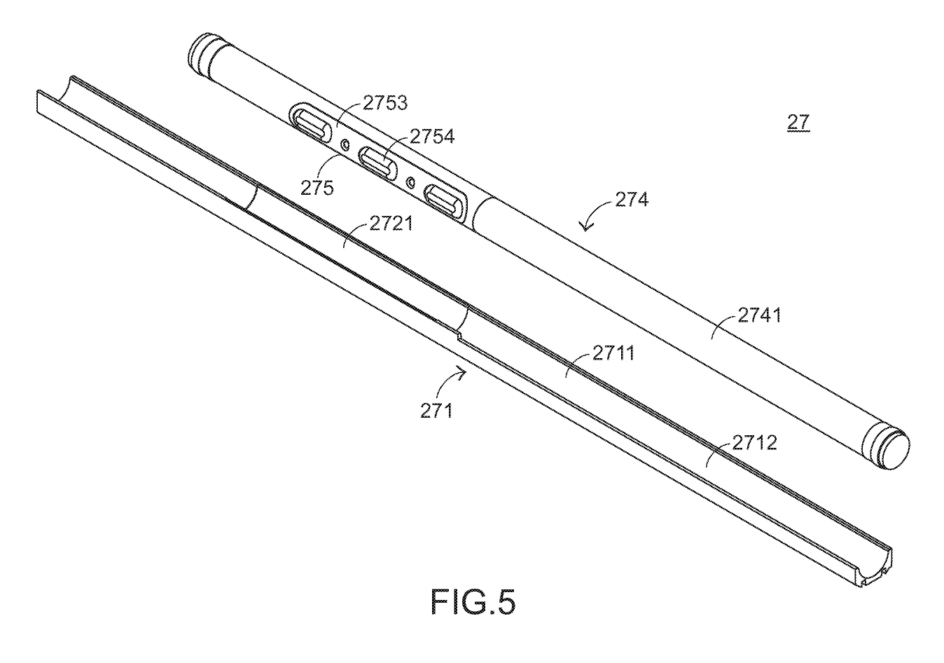

FIG. 5 is a schematic exploded view illustrating a control device according to a fifth embodiment of the present invention. In this embodiment, the control device 27 may be also referred as a rollable and linearly-translatable control device. The rollable and linearly-translatable control device 27 comprises a holder 271 and a roll-bar-type movable member 274. The holder 271 comprises a trench 2712 for providing a supporting surface 2711 and accommodating the roll-bar-type movable member 274. A flexible print circuit board 2721 for providing the sensing member is located at one side of the supporting surface 2711. An outer surface of the movable member 274 comprises an operable surface 2741 and a surface of a displacement generation member 275. The operable surface 2741 does not overlap the displacement generation member 275.

In this embodiment, the operable surface 2741 may be further provided with several anti-slide patterns for enhancing the touch feel of touching the operable surface 2741. The examples of the anti-slide patterns include but are not limited to convex structures or concave structures with linear strip-shaped, curved strip-shaped, saw-toothed or spiral strip-shaped geometric profiles, wherein the convex structures or the concave structures are parallel or not parallel with the second longitudinal direction. These convex structures or concave structures may be continuously or discontinuously, symmetrically or asymmetrically, regularly or irregularly distributed on the operable surface 2741. Alternatively, in some other embodiments, the anti-slide pattern is a unit structure with a block shape (e.g. a circular shape, an elliptic shape, an irregular polygonal shape, a regular polygonal shape or a dot shape).

As shown in FIG. 5, the displacement generation member 275 comprises a carrier 2753 and a conductive structure 2754 (e.g. a convex structure made of a conductive cloth). As the roll-bar-type movable member 274 is linearly translated by the user, at least a portion of the conductive structure 2754 overlaps the sensing member of the flexible print circuit board 2721 to generate an interaction. According to the interaction, a first control signal is generated to control the movement of the cursor along the X-axis direction or the Y-axis direction. Of course, the roll-bar-type movable member 274 may be provided with plural displacement generation members 275 along the direction parallel with the second longitudinal direction, wherein each of the plural displacement generation members 275 comprises the combination of the carrier 2753 and the conductive structure 2754. Consequently, as the roll-bar-type movable member 274 is rolled by the user, the overlap between the plural displacement generation members 275 and the sensing member is assured.

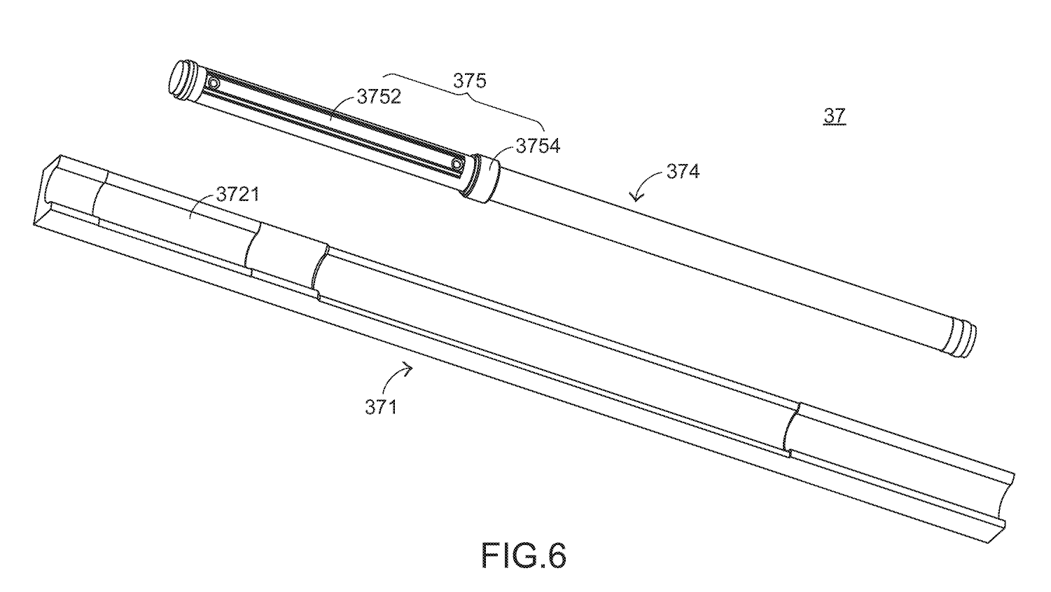

FIG. 6 is a schematic exploded view illustrating a control device according to a sixth embodiment of the present invention. The control device 37 comprises a roll-bar type removable member 374 and a holder 371. In comparison with the fifth embodiment, the displacement generation member 375 comprises plural conductive blocks 3752 and a conductive block 3754. The conductive blocks 3752 are metal sheets, conductive plates or conductive layers. The conductive block 3754 is a closed ring, which is sheathed around the roll-bar type removable member 374. For detecting the linear translation of the roll-bar type removable member 374, the arrangement of the closed ring-shaped conductive block 3754 may assure the overlap between a portion of the conductive block 3754 and the sensing member of the flexible print circuit board 3721 in order to result in the interaction. For detecting the rolling action of the removable member 374, the arrangement of the plural conductive blocks 3752 on the roll-bar type removable member 374 may assure the overlap between one of the plural conductive blocks 3752 and the sensing member of the flexible print circuit board 3721 in order to result in the interaction.

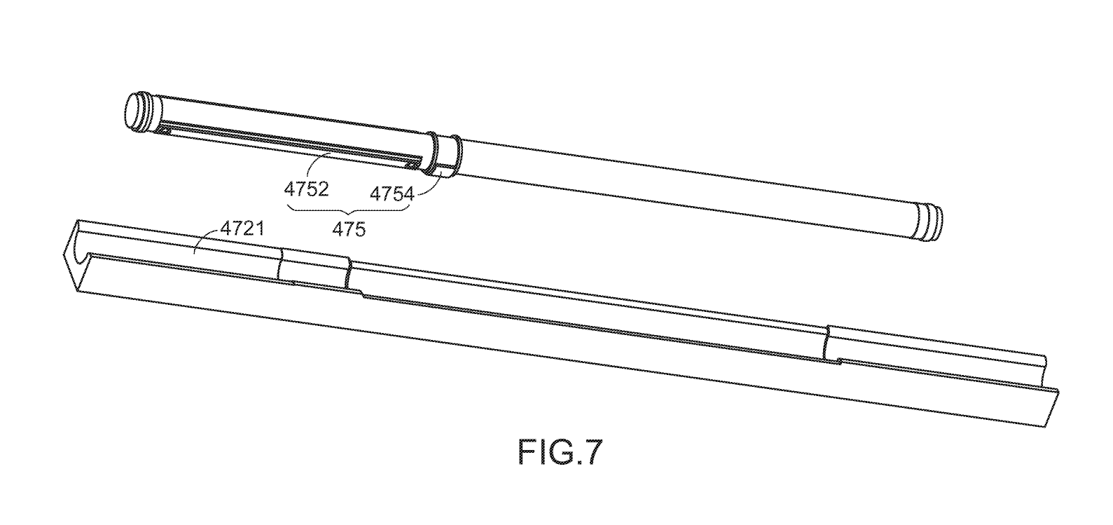

FIG. 7 is a schematic exploded view illustrating a control device according to a seventh embodiment of the present invention. In comparison with the sixth embodiment, the displacement generation member 475 comprises plural conductive blocks 4752 and a conductive block 4754. The conductive blocks 4752 are similar to the conductive blocks 3752. In contrast, the conductive block 4754 conductive block 4754 is an open-type conductive ring or metal ring. Since the conductive block 4754 is not a closed ring-shaped structure, the length or the area of the conductive block 4754 should be large enough to assure the overlap between a portion of the conductive block 3754 and the sensing member of the flexible print circuit board 4721 in order to result in the interaction.

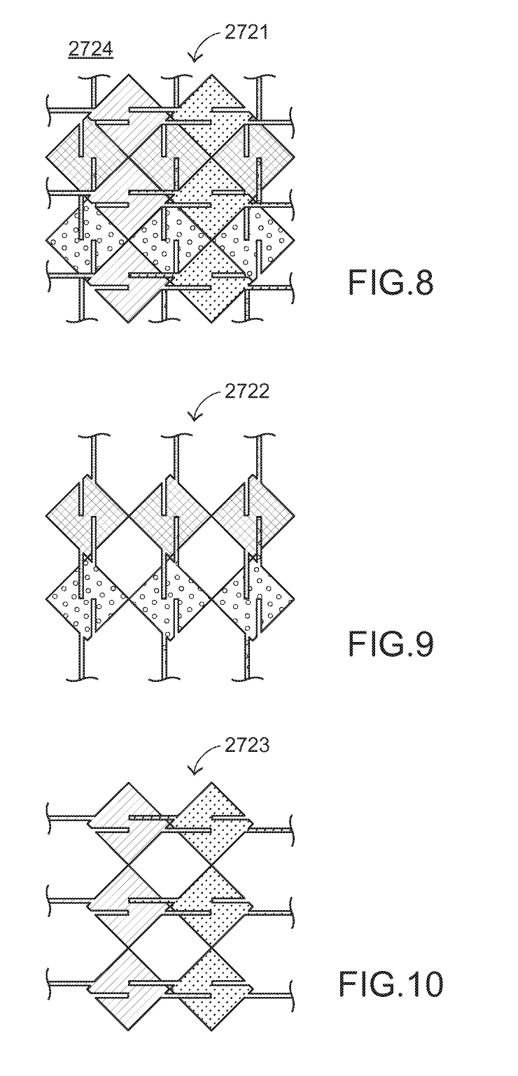

Hereinafter, an exemplary sensing member used in the control device of the fifth, sixth or seventh embodiment will be illustrated with reference to FIGS. 8, 9 and 10. FIG. 8 is a schematic planar view illustrating an exemplary sensing member used in the control device of the present invention. FIG. 9 is a schematic planar view illustrating a first sensing pattern of the sensing member of FIG. 8. FIG. 10 is a schematic planar view illustrating a second sensing pattern of the sensing member of FIG. 8. As shown in FIGS. 8, 9 and 10, a portion of the flexible print circuit board 2721 is provided with a sensing member 2724, which includes a first sensing pattern 2722 and a second sensing pattern 2723. In comparison with the sensing members used in the first, second, third and fourth embodiments, the first sensing pattern 2722 responsible for sensing the linear translation and the second sensing pattern 2723 responsible for sensing the rolling action are located adjacent to each other in a staggered form in order to construct the sensing member 2724. In a case that the flexible print circuit board 2721 is a multilayered circuit board, the first sensing pattern 2722 and the second sensing pattern 2723 may be formed on the same layer or different layers of the flexible print circuit board 2721. It is noted that the configurations of the first sensing pattern 2722 and the second sensing pattern 2723 may be also applied to the control device of the first, second, third or fourth embodiment. Moreover, the configurations of the sensing member 2724 are presented herein for purpose of illustration and description only.

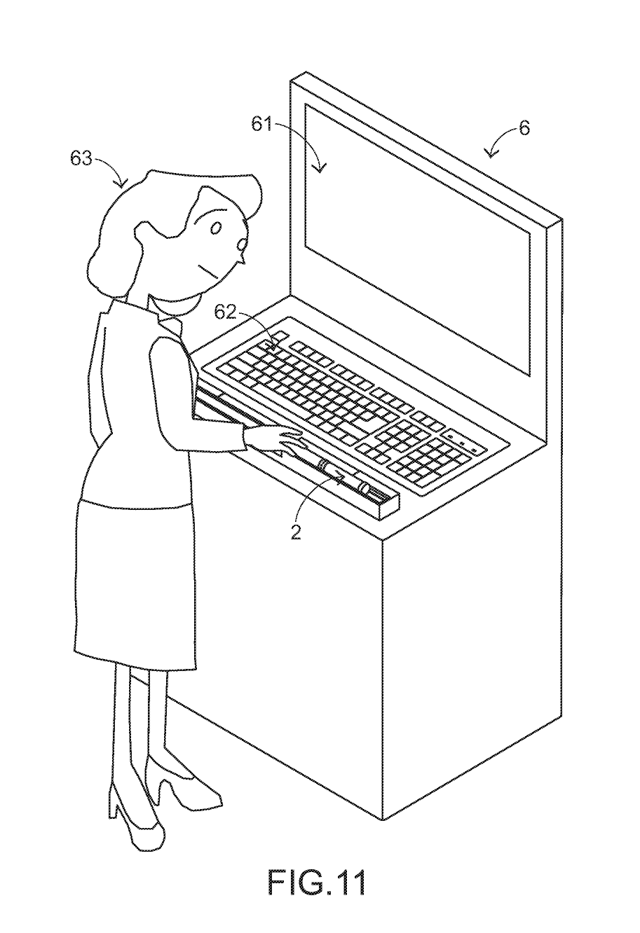

FIG. 11 is a schematic perspective view illustrating a first application environment of the control device according to the first embodiment of the present invention. For example, the control device 2 of the present invention may be applied to the general fixed-type query machine 6. For example, the query machine 6 is installed in a supermarket for allowing a standing customer 63 to inquire about the product information or operate a virtual shop. Generally, the query machine 6 comprises a display screen 61 and a keyboard device 62. Since the control device 2 of the present invention has small volume, the control device 2 can be installed on a limited platform of the fixed-type query machine 6. Under this circumstance, the control device 2 can be operated as a mouse by the customer 63. In other words, the use of the control device 2 of the present invention can facilitate the customer 63 to operate the fixed-type query machine 6.

FIG. 12 is a schematic perspective view illustrating a second application environment of the control device according to the first embodiment of the present invention. The control device 2 of the present invention may be applied to a movable workstation 7 such as a movable workstation of a medical unit. In views of the mobile convenience, the general movable workstation 7 has a limited space for receiving an electronic device 71. The limited area of the platform of the movable workstation 7 becomes hindrance from operating the conventional mouse by a standing worker 73. Consequently, a keyboard device 72 and the control device 2 of the present invention may be integrated into the electronic device 71. Since the control device 2 of the present invention only needs a fixed and limited space, the control device 2 can be operated as a mouse by the worker 73. Moreover, since it is not necessary to move the control device 2 during the control device 2 is operated, the operating convenience is enhanced.

From the above descriptions, the control device of the present invention is suitably applied to a platform environment with a limited space. The control device of the present invention is easily operated by the standing user in order to enhance the flexibility of operating the electronic device.

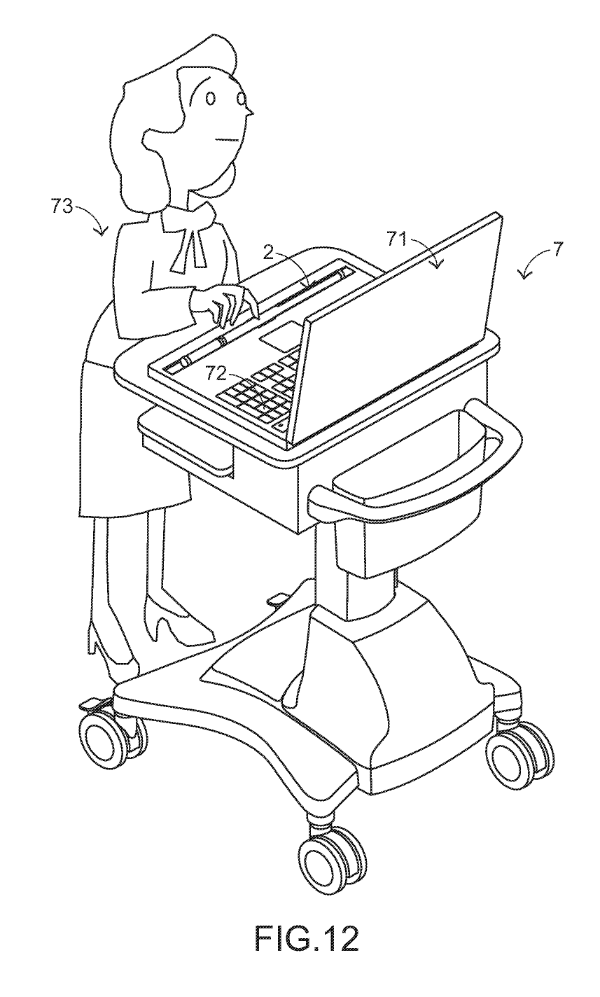

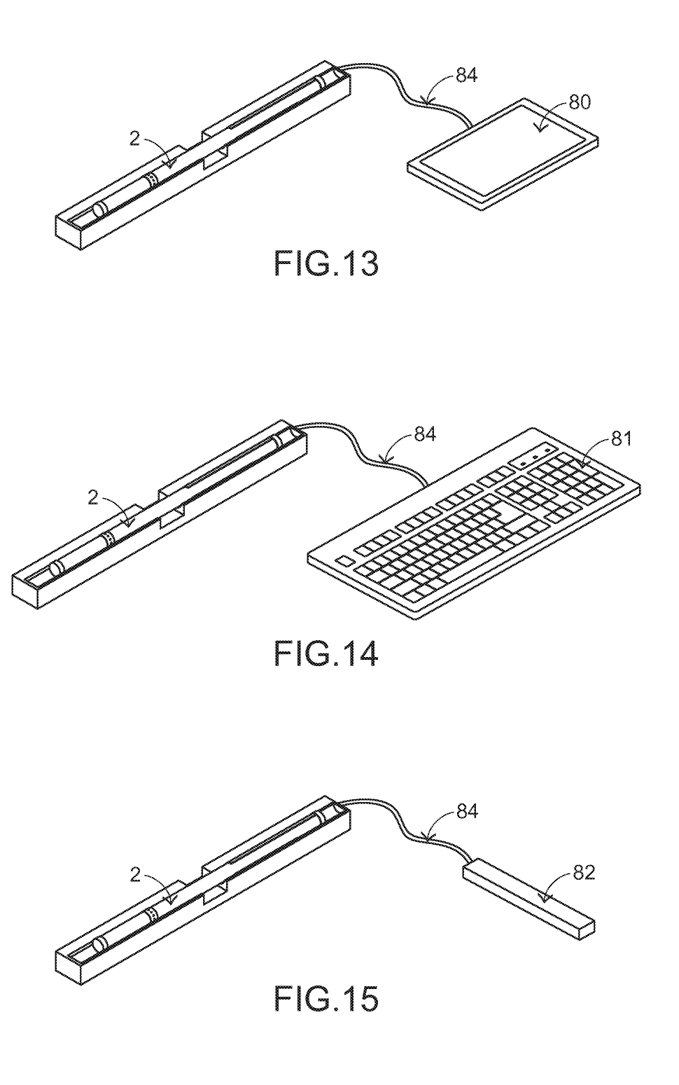

FIG. 13 is a schematic perspective view illustrating a control device according to an eighth embodiment of the present invention. FIG. 14 is a schematic perspective view illustrating a control device according to a ninth embodiment of the present invention. FIG. 15 is a schematic perspective view illustrating a control device according to a tenth embodiment of the present invention. The control device 2 further comprises other peripheral modules in order to execute more functions. For example, as shown in FIG. 13, the control device 2 is in communication with a touchpad 80 through a transmission wire 84. As shown in FIG. 14, the control device 2 is in communication with a keyboard module 81 through the transmission wire 84. As shown in FIG. 15, the control device 2 is in communication with a scanning module 82 through the transmission wire 84. In FIGS. 13, 14 and 15, the control device 2 may be in communication with the touchpad 80, the keyboard module 81 or the scanning module 82 in a wired transmission manner. Moreover, in a case that the circuit module (not shown) of the control device 2 is elaborately designed, the control device 2 may be in communication with the touchpad 80, the keyboard module 81 or the scanning module 82 in a wireless transmission manner. When the touchpad 80, the keyboard module 81 or the scanning module 82 is operated by the user, the output signals may be transmitted to the external electronic device through the control device 2 in order to control the inputting action of the external electronic device. Moreover, in a case that the touchpad 80, the keyboard module 81 or the scanning module 82 is in a non-usage state, the control device 2 may be detached from the touchpad 80, the keyboard module 81 or the scanning module 82. Alternatively, the control device 2 and the touchpad 80, the keyboard module 81 or the scanning module 82 may be stored together.

In the embodiments about the application environment of the control device as shown in FIGS. 11 and 12, or in the embodiments about the touchpad 80, the keyboard module 81 or the scanning module 82 as shown in FIGS. 13-15, the control device of the present invention is used with an electronic device collaboratively, but is not limited thereto. It is noted that the control device of the present invention may be applied to other electronic device. The electronic device includes for example another type touch module, a projecting module, a camera module, an industrial computer or host, a commercial computer or host, a medical computer or host, a handheld electronic device, or a combination of at least two of the above electronic devices.

From the above descriptions, the present invention provides a control device. In the conventional control device, an optical sensor, a magnetic sensor or an image sensor is used to detect the controlling action of the user. In the control device of the present invention, the sensing member and the displacement generation member are collaboratively used to detect the controlling action of the user. Consequently, the flexibility of designing the control device is enhanced, the accurate controlling efficacy is maintained or generated, and the comfort of operating the control device is increased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control device for controlling a movement of a cursor of an electronic device, said control device comprising:
a supporting surface extended along a first longitudinal direction;
a sensing member;
a displacement generation member facing said sensing member; and
a movable member extended along a second longitudinal direction, and linearly translatable along said first longitudinal direction of said supporting surface,
wherein when said second longitudinal direction of said movable member is parallel with said first longitudinal direction and said movable member is linearly translated along said first longitudinal direction or rolled along a direction perpendicular to said first longitudinal direction, a displacement of said movable member relative to said supporting surface synchronously results in a displacement of said displacement generation member relative to said sensing member, and a first control signal is generated in response to an interaction between said displacement generation member and said sensing member.

2. The control device according to claim 1, further comprising a circuit board for providing said sensing member, wherein said displacement generation member is disposed on an outer surface of said movable member that faces said circuit board.

3. The control device according to claim 2, further comprising:
a holder or a supporting rod for providing said supporting surface to support said circuit board or fixing said circuit board, wherein a length of said movable member along said second longitudinal direction is shorter than a length of said holder or said supporting rod along said first longitudinal direction; or
a holder or a supporting rod for providing said supporting surface and a casing for supporting said circuit board, wherein said circuit board is arranged between said casing and said holder or said supporting rod, and wherein said movable member is sheathed around said supporting surface of said holder or said supporting rod, and wherein a length of said movable member along said second longitudinal direction is shorter than a length of said holder or said supporting rod along said first longitudinal direction.

4. The control device according to claim 1, further comprising a circuit board for providing said sensing member and a holder or a supporting rod for providing said supporting surface and supporting said circuit board, wherein said displacement generation member is disposed on an inner surface of said movable member that faces said circuit board, and wherein a length of said movable member along said second longitudinal direction is shorter than a length of said holder or said supporting rod along said first longitudinal direction.

5. The control device according to claim 1, further comprising a circuit board for providing said sensing member, and wherein said displacement generation member comprises at least one conductive structure, and said interaction is generated by touching or non-touching said sensing member with said conductive structure of said generation member, and said interaction comprises resistive interaction or capacitive interaction.

6. The control device according to claim 1, further comprising:
a wired connecting interface or a wireless transmission interface for outputting said first control signal; or
a wired connecting interface or a wireless transmission interface for outputting said first control signal and a peripheral module in communication with said wired connecting interface or said wireless transmission interface, wherein said peripheral module and said control device are combined together or separated into two parts, wherein said peripheral module at least comprises a scanning module, a keyboard module, a touch module, a projecting module, a camera module, an industrial computer or host, a commercial computer or host, a medical computer or host, a handheld electronic device, or a combination thereof.

7. The control device according to claim 1, further comprising a supporting rod or a holder for providing said supporting surface and a circuit board for providing said sensing member, wherein said displacement generation member is disposed on said supporting surface, and said circuit board is disposed on an inner surface of said movable member that faces said supporting surface of said supporting rod or said holder.

8. The control device according to claim 1, further comprising a supporting rod or a holder for providing said supporting surface, wherein said displacement generation member is disposed on said supporting surface, and said movable member is sheathed around said supporting surface and said displacement generation member, wherein a length of said movable member along said second longitudinal direction is shorter than a length of said supporting rod or said holder along said first longitudinal direction.

9. The control device according to claim 1, further comprising a supporting rod or a holder for providing said supporting surface, wherein said displacement generation member comprises at least one conductive structure disposed on said supporting surface, wherein said interaction is generated by touching or non-touching said sensing member with said conductive structure of said displacement generation member.

10. The control device according to claim 1, further comprising a casing for supporting said displacement generation member and a supporting rod or a holder for providing said supporting surface, wherein said movable member is sheathed around said supporting rod or said holder, and said sensing member is disposed on an outer surface of said movable member, wherein said outer surface of said movable member is arranged between said supporting rod and said casing, or said outer surface of said movable member is arranged between said holder and said casing.

11. A rollable and linearly-translatable control device for controlling a movement of a cursor of an electronic device, said rollable and linearly-translatable control device comprising:
a displacement generation member;
a movable member rollable or linearly translatable on a supporting surface to be operated by a user, wherein when said movable member is rolled, a central axis of said movable member is served as a rolling shaft; and
a sensing member,
wherein when said movable member is rolled or linearly translated relative to said supporting surface, a displacement of said movable member relative to said supporting surface synchronously results in an interaction between said displacement generation member and said sensing member, and a first control signal is generated in response to said interaction.

12. The rollable and linearly-translatable control device according to claim 11,
wherein said displacement generation member comprises at least one conductive structure, which is disposed on an outer surface of said movable member, wherein said control device further comprises a holder for providing said supporting surface and a flexible printed circuit board, and said sensing member is provided by said flexible printed circuit board, wherein when said movable member is rolled or linearly translated on said supporting surface, at least a portion of said conductive structure overlaps said sensing member of said flexible printed circuit board; or
wherein said displacement generation member comprises plural conductive blocks distributed on an outer surface of said movable member, wherein said control device further comprises a holder for providing said supporting surface and a flexible printed circuit board on which a first sensing pattern and a second sensing pattern of said sensing member are distributed, wherein when said movable member is rolled or linearly translated on said supporting surface, at least one of said plural conductive blocks overlaps at least one of said first sensing pattern and said second sensing pattern.

13. The rollable and linearly-translatable control device according to claim 12, further comprising a peripheral module for receiving said first control signal, wherein said peripheral module and said control device are combined together or separated into two parts, wherein said peripheral module at least comprises a scanning module, a keyboard module, a touch module, a projecting module, a camera module, an industrial computer or host, a commercial computer or host, a medical computer or host, a handheld electronic device, or a combination thereof.

14. The rollable and linearly-translatable control device according to claim 12, wherein if said displacement generation member comprises said at least one conductive structure, said conductive structure is selected from a metal sheet, a conductive cloth, a conductive bump, or a combination thereof, wherein if said displacement generation member comprises said plural conductive blocks, said plural conductive blocks comprise plural separate metal sheets, plural separate conductive cloths, plural separate conductive bumps, or a combination thereof.

15. The rollable and linearly-translatable control device according to claim 11,
wherein said displacement generation member comprises at least one conductive structure disposed on an inner surface of said movable member, wherein said control device further comprises a holder for providing said supporting surface and a flexible printed circuit board that provides said sensing member, wherein when said movable member is rolled or linearly translated on said supporting surface, at least a portion of said conductive structure overlaps said sensing member of said flexible printed circuit board; or
wherein said displacement generation member comprises plural conductive blocks distributed on an inner surface of said movable member, wherein said control device further comprises a holder for providing said supporting surface and a flexible printed circuit board on which a first sensing pattern and a second sensing pattern of said sensing member are distributed, wherein when said movable member is rolled or linearly translated on said supporting surface, at least one of said plural conductive blocks overlaps at least one of said first sensing pattern and said second sensing pattern.

16. The rollable and linearly-translatable control device according to claim 11, wherein
wherein said control device further comprises a holder for providing said supporting surface and a flexible printed circuit board for providing said sensing member, wherein said flexible printed circuit board is disposed on said movable member, and said displacement generation member comprises at least one conductive structure disposed on said holder, wherein when said movable member is rolled or linearly translated on said supporting surface, at least a portion of said conductive structure overlaps said sensing member of said flexible printed circuit board; or
wherein said control device further comprises a holder for providing said supporting surface and a flexible printed circuit board for providing said sensing member, wherein said flexible printed circuit board is disposed on said movable member, wherein said displacement generation member comprises plural conductive blocks distributed on said holder, wherein a first sensing pattern and a second sensing pattern of said sensing member are distributed on said flexible printed circuit board, wherein when said movable member is rolled or linearly translated on said supporting surface, at least one of said plural conductive blocks overlaps at least one of said first sensing pattern and said second sensing pattern.

17. A control device for controlling a movement of a cursor of an electronic device, said control device comprising:
a displacement generation member;
a movable member rollable or linearly translatable on a supporting surface to be operated by a user; and
a flexible printed circuit board with a sensing member,
wherein when said movable member is rolled or linearly translated relative to said supporting surface, a displacement of said movable member relative to said supporting surface synchronously results in an interaction between said displacement generation member and said sensing member, and a first control signal is generated in response to said interaction.

18. The control device according to claim 17,
wherein said displacement generation member comprises at least one conductive structure disposed on an outer surface of said movable member, wherein said control device further comprises a holder for providing said supporting surface and accommodating said movable member and said flexible printed circuit board, wherein said sensing member comprises both a first sensing pattern and a second sensing pattern distributed on said flexible printed circuit board, wherein when said movable member is rolled or linearly translated on said supporting surface, said conductive structure overlaps at least one of said first sensing pattern and said second sensing pattern; or
wherein said displacement generation member comprises at least one conductive structure disposed on an inner surface of said movable member, wherein said control device further comprises a holder for providing said supporting surface and accommodating said movable member, wherein said sensing member comprises both a first sensing pattern and a second sensing pattern distributed on said flexible printed circuit board, wherein when said movable member is rolled or linearly translated on said supporting surface, said conductive structure overlaps at least one of said first sensing pattern and said second sensing pattern; or
wherein said displacement generation member comprises plural conductive blocks distributed on an outer surface of said movable member, wherein said control device further comprises a holder for providing said supporting surface and accommodating said movable member and said flexible printed circuit board, wherein said sensing member comprises both a first sensing pattern and a second sensing pattern distributed on said flexible printed circuit board, wherein when said movable member is rolled or linearly translated on said supporting surface, at least one of said plural conductive blocks overlaps at least one of said first sensing pattern and said second sensing pattern; or
wherein said displacement generation member comprises plural conductive blocks, which are distributed on an inner surface of said movable member, wherein said control device further comprises a holder for providing said supporting surface and accommodating said movable member and said flexible printed circuit board, wherein said sensing member comprises both a first sensing pattern and a second sensing pattern distributed on said flexible printed circuit board, wherein when said movable member is rolled or linearly translated on said supporting surface, at least one of said plural conductive blocks overlaps at least one of said first sensing pattern and said second sensing pattern.

19. The control device according to claim 18, wherein said first sensing pattern and said second sensing pattern are distributed on said flexible printed circuit board, and said first sensing pattern and said second sensing pattern are separated from each other, located adjacent to each other or staggered relative to each other, wherein if said displacement generation member comprises said at least one conductive structure, said conductive structure is selected from a metal sheet, a conductive cloth, a conductive bump, or a combination thereof, wherein if said displacement generation member comprises said plural conductive blocks, said plural conductive blocks comprise plural separate metal sheets, plural separate conductive cloths, plural separate conductive bumps, or a combination thereof.

20. The control device according to claim 17, further comprising a peripheral module for receiving said first control signal in a wired transmission manner or a wireless transmission manner, wherein said peripheral module and said control device are combined together or separated into two parts, wherein said peripheral module at least comprises a scanning module, a keyboard module, a touch module, a projecting module, a camera module, an industrial computer or host, a commercial computer or host, a medical computer or host, a handheld electronic device, or a combination thereof.

21. The control device according to claim 17,
wherein said control device further comprises a holder for providing said supporting surface, wherein said flexible printed circuit board is disposed on said movable member, and said displacement generation member comprises at least one conductive structure disposed on said holder, wherein said sensing member comprises both a first sensing pattern and a second sensing pattern distributed on said flexible printed circuit board, wherein when said movable member is rolled or linearly translated on said supporting surface, said conductive structure overlaps at least one of said first sensing pattern and said second sensing pattern; or
wherein said control device further comprises a holder for providing said supporting surface, wherein said flexible printed circuit board is disposed on said movable member, and said displacement generation member comprises plural conductive blocks disposed on said holder, wherein said sensing member comprises both a first sensing pattern and a second sensing pattern distributed on said flexible printed circuit board, wherein when said movable member is rolled or linearly translated on said supporting surface, at least one of said plural conductive blocks overlaps at least one of said first sensing pattern and said second sensing pattern.

22. A control device for controlling a movement of a cursor of an electronic device, said control device comprising:
a touch-type displacement generation member;
a roll-bar-type removable member rollable or linearly translatable on a supporting surface to be operated by a user; and
a touch-type sensing member,
wherein when said roll-bar-type movable member is rolled or linearly translated relative to said supporting surface, a displacement of said roll-bar-type movable member relative to said supporting surface synchronously results in an interaction between said touch-type displacement generation member and said touch-type sensing member, and a first control signal is generated in response to said interaction.

23. The control device according to claim 22,
wherein said control device further comprises a holder for providing said supporting surface and a flexible printed circuit board for providing said sensing member, wherein said displacement generation member comprises at least one conductive structure disposed on a surface of said roll-bar-type removable member, wherein said touch-type sensing member comprises a first sensing pattern and a second sensing pattern, wherein when said roll-bar-type removable member is rolled or linearly translated on said supporting surface, at least a portion of said conductive structure overlaps at least one of said first sensing pattern and said second sensing pattern of said flexible printed circuit board; or
wherein said control device further comprises a holder for providing said supporting surface and a flexible printed circuit board, wherein said displacement generation member comprises plural conductive blocks distributed on a surface of said roll-bar-type removable member, wherein said touch-type sensing member comprises both a first sensing pattern and a second sensing pattern distributed on said flexible printed circuit board, wherein when said roll-bar-type removable member is rolled or linearly translated on said supporting surface, at least one of said plural conductive blocks overlaps at least one of said first sensing pattern and said second sensing pattern.

24. The control device according to claim 23, wherein the surface of said roll-bar-type removable member is an inner surface or an outer surface.

25. The control device according to claim 24, further comprising a peripheral module for receiving said first control signal in a wired transmission manner or a wireless transmission manner, wherein said peripheral module and said control device are combined together or separated into two parts, wherein said peripheral module at least comprises a scanning module, a keyboard module, a touch module, a projecting module, a camera module, an industrial computer or host, a commercial computer or host, a medical computer or host, a handheld electronic device, or a combination thereof.

26. The control device according to claim 23, wherein said first sensing pattern and said second sensing pattern are distributed on said flexible printed circuit board, and said first sensing pattern and said second sensing pattern are separated from each other, located adjacent to each other or staggered relative to each other, wherein if said displacement generation member comprises said at least one conductive structure, said conductive structure is selected from a metal sheet, a conductive cloth, a conductive bump, or a combination thereof, wherein if said displacement generation member comprises said plural conductive blocks, said plural conductive blocks comprise plural separate metal sheets, plural separate conductive cloths, plural separate conductive bumps, or a combination thereof.

27. The control device according to claim 22, wherein
wherein said control device further comprises a holder for providing said supporting surface, wherein said flexible printed circuit board is disposed on said roll-bar-type movable member, and said displacement generation member comprises at least one conductive structure, which is disposed on said holder, wherein a first sensing pattern and a second sensing pattern of said touch-type sensing member are distributed on said flexible printed circuit board, wherein when said movable member is rolled or linearly translated on said supporting surface, at least a portion of said conductive structure overlaps at least one of said first sensing pattern and said second sensing pattern; or
wherein said control device further comprises a holder for providing said supporting surface, wherein said flexible printed circuit board is disposed on said roll-bar-type movable member, and said displacement generation member comprises plural conductive blocks disposed on said holder, wherein a first sensing pattern and a second sensing pattern of said touch-type sensing member are distributed on said flexible printed circuit board, wherein when said movable member is rolled or linearly translated relative to said supporting surface, at least one of said plural conductive blocks overlaps at least one of said first sensing pattern and said second sensing pattern.
